(19) United States
(12) Patent Application Publication
(10) Pub. No.: US 2002/0139313 A1
(43) Pub. Date: Oct. 3, 2002

(54) Pet debris trap and method

(76) Inventors: Joe. D. Mack JR., Inglewood, CA (US); Alfred Vallejo, Los Angeles, CA (US); Kevin G. Abelbeck, Los Angeles, CA (US)

Correspondence Address: Kevin Abelbeck, 2524 S. Sepulveda Blvd., #302, Los Angeles, CA, 90064, US

(21) Appl. No.: 09/824,888

(22) Filed: Apr. 2, 2001

(51) Int. Cl. A01K 29/00

(52) U.S. Cl. 119/165

(57) ABSTRACT

A pet debris trap catches items that result from traffic to a pet usage area, such as a cat litter box, or from a pet habitat such as a birdcage. In situations such as this, debris in the form of cat litter, feces, food particles, replaced feathers, etc., are deposited around the litter box or habitat. This presents a condition that requires constant attention by the pet owner. As a solution to this problem the present invention is a trap that includes a substratum that supports an adhesive, preferably a pressure sensitive adhesive, which is supported by, and positioned up away from, a base. This accessible adhesive catches litter that clings to the paws of a cat or droppings from a bird that would otherwise soil the bottom pan of the cage or bounce out of the cage and land on the floor nearby. The adhesive covered substratum can come in individual sheets or on a continuous roll, which can then be discarded when soiled and replaced with a clean sheet or section of the roll.

### FIELD OF THE INVENTION

The present invention generally relates to household pet devices. More specifically, the present invention relates to a device intended to prevent soiling of the area near a litter box or pet habitat.

### BACKGROUND OF THE INVENTION

The problems associated with household pets are encountered by all pet owners at some time. Many such problems are associated with the fecal contaminants and associated odor of housecats. Technology in cat litter has enabled a greatly reduced odor problem. Unfortunately the litter itself presents another problem. The very nature of cat litter is extensive and rapid absorption. These absorption properties are enhanced by providing a high surface area of the absorbing material. Inherently, this means small granular particles that the cat must step into every time the litter box is used. The soft paws of the animal pick up this material and deposit it in the general vicinity of the litter box. Every owner of an indoor cat has dealt with the constant sweeping of the litter box area to keep it clean. With every use by the cat, the area is again soiled.

A similar problem exists with indoor birds. Birds do not use a litter box. Instead they freely defecate at will to the obvious detriment of anything lying there below. In addition, not only are birds less than sanitary with their fecal waste, but the food they partially eat and drop or drop prior to eating typically lands in the pan, or bottom of the cage. Old newspaper is typically used to line the bottom of the cage in an attempt to catch the falling debris. For some items this works but for hard objects, such as nuts and shells, an elastic collision between the object and the bottom of the cage pan results in a projectile that eventually lands on the floor around the cage. The result of both the litter box and the birdcage, is an untidy floor littered with debris.

A few attempts have been made to address these problems, but most involve a screen with a second pad that then also needs to be emptied. The structures of such devices are usually costly. In many cases these attempted “traps” will be avoided by the animal. An inexpensive and potentially retrofitable product that works with the existing litter box or other habitat is desirable.

### SUMMARY OF THE INVENTION

In one aspect, the invention features a substantially rigid base and a substratum with an adhesive, preferably a pressure sensitive adhesive, on a first side and a second side positioned on the base. The substratum is releasably fastened to the base so that the adhesive on the first side of the substratum would capture debris from a pet, such as cat litter, bird food and fecal waste.

The pet debris trap may also include a base that is manufactured of a substantially flat paperboard material, such as a cardboard sheet. The base may be comprised of a formed structure and include a substratum clamp. The formed structure can be manufactured from metal, plastic, wood or any other similar material. This formed structure can take the form of the pan of a birdcage or a cat litter box ramp. The structure may include one or more sidewalls that may be releasably secured to the formed structure.

The substratum, which supports the adhesive, of the trap may include a plurality of stacked sheets that are releasably fastened to the base at one end of the stack with a gum adhesive. These sheets may include a release liner on each sheet, when the release liner is removed access to the adhesive is provided.

In another form the substratum may be comprised of a roll of pliable material with the first side (adhesive side) being the medial portion of each layer of the roll. The base may also include a roll support that is capable of receiving the substratum roll. A cutter may also be included to enable separation of a portion of the substratum from the roll.

In another aspect, the invention includes a method of capturing pet debris including providing a device in accordance with that as previously disclosed, positioning the device in a pet area with the first side of the substratum, and associated adhesive, accessible to the debris and then allowing the adhesive to capture the debris. The method may also include removing the substratum when it is soiled and replacing it with an unsoiled substratum and associated adhesive.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is an isometric view of a pet debris trap with an adhesive applied substratum in the form of a multiple sheet tablet with release liners, the device produced in accordance with the present invention.

FIG. 2 is an isometric view of a multiple sheet tablet, as in FIG. 1, positioned as it would typically be used with a housed litter box, the device produced in accordance with the present invention.

FIG. 3 is an isometric view of roll of a pet debris trap with an adhesive applied substratum in the form of a roll shown in a typical application lining the bottom pan of a birdcage, the device produced in accordance with the present invention.

FIG. 4 is an isometric, exploded view of a pet debris trap with an adhesive applied substratum in the form of a roll, the device including a litter box ramp with a substratum clamp and a cutter near the roll, the device shown next to a cat litter box.

FIG. 5 is an isometric, assembled view of a pet debris trap with an adhesive applied substratum in the form of a roll, the device including a litter box ramp with a cutter positioned near the end of the ramp.

FIG. 6 is a side, shortened view of an assembled pet debris trap with an adhesive applied substratum in the form of a roll, the device including a litter box ramp with a cutter positioned near the substratum roll and a clamp near the end of the ramp.

FIG. 7 is a side, shortened view of an assembled pet debris trap with an adhesive applied substratum in the form of a roll, the device including a litter box ramp with a cutter positioned near the end of the ramp.

FIG. 8 is an isometric view of a pet debris trap with an adhesive applied substratum in the form of a roll, the device including a litter box ramp with a side wall releasably secured thereto, the device shown as it would typically be used with a cat litter box.

For the most part, and as will be apparent when referring to the figures, when an item is used unchanged in more than one figure, it is identified by the same alphanumeric reference indicator in all figures.

### DETAILED DESCRIPTION OF THE PREFERRED EMBODIMENT

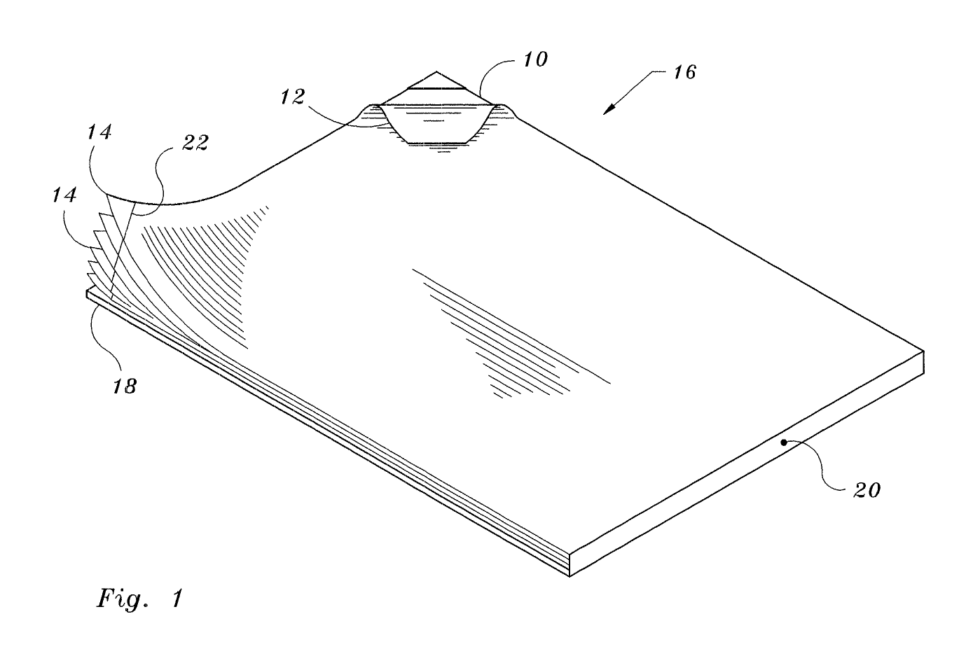

The present invention is pet debris trap that is intended to reduce or eliminate traditional cleanup around a high pet traffic object such as a litter box of a cat or animal habitat such as a birdcage. One form of the disclosed invention is shown in FIG. 1. Here the substratum 10 includes an adhesive layer on this, the upper side. A release liner 12 is placed over the substratum 10, covering the adhesive until such time as the release liner 12 is pealed away, exposing the adhesive. The combination of the substratum 10 and the liner 12 can be in the form of a sheet 14, as shown here. These sheets 14 can be stacked into a pad 16 and supported by a base 18. The base gives the pad 16 a reasonable amount of rigidity that enables the “sticky” surface of the adhesive lined substratum 10 to stay in place when the adhesive on the substratum is contacted and released. The base 18 can take any number of forms and is preferably a paper material such as a flat cardboard sheet. Cardboard is inexpensive and more environmentally friendly than plastics or metals, though both could function in this regard.

In the preferred embodiment, the substratum 10, or in this case sheets 14 are attached to the base 18 at only one end. That is the shown here to be by use of gum adhesive 20, located on one edge of the pad 16. This allows the release liners 12 of each sheet 14 and each individual sheet 14 to be removed from the pad 16 at the discretion of the user. This is desirable when a substratum is soiled and replacement is desired.

Though many of the specifics of the substratum 10 are not critical to the function of the invention, the preferred embodiment, as determined by the inventors, has revealed some specifications. The substratum 10 is preferably an 80# tan or buff paper (approximately 0.005-0.007 inches thick) with a pressure sensitive adhesive on one side. The adhesive is preferably of an acrylic or rubber base and must be sticky to the touch but not “stringy” in that it must remain on the substratum 10 when contacted and released.

The release liner is a coated paper of similar thickness or thinner (approximately 0.004-0.007 inches thick) than the substratum 10. A score line 22 is used to facilitate removal of the release liner 12 from the substratum 10. The score line 22 is shown here to be a 45-degree cut through the release liner 12 near the free edges of each sheet 14. This is found to be optimal but not critical to the function of the invention. An infinite number of variations in the number and positions of the score lines are possible without altering the intended function of the invention.

The base 18, as noted, can easily take a variety of forms in that the only function is to support the substratum 10. In the preferred embodiment, the base 18 is comprised of an uncoated paperboard approximately 0.025-0.050 inches thick.

The combined pad 16 has been determined to function optimally in this form with a size of 20 inches in width (width of the gum adhesive) by 26 inches in length. It is understood that an infinite variety of dimensions can be used and this is not intended to be limiting to the scope of the invention.

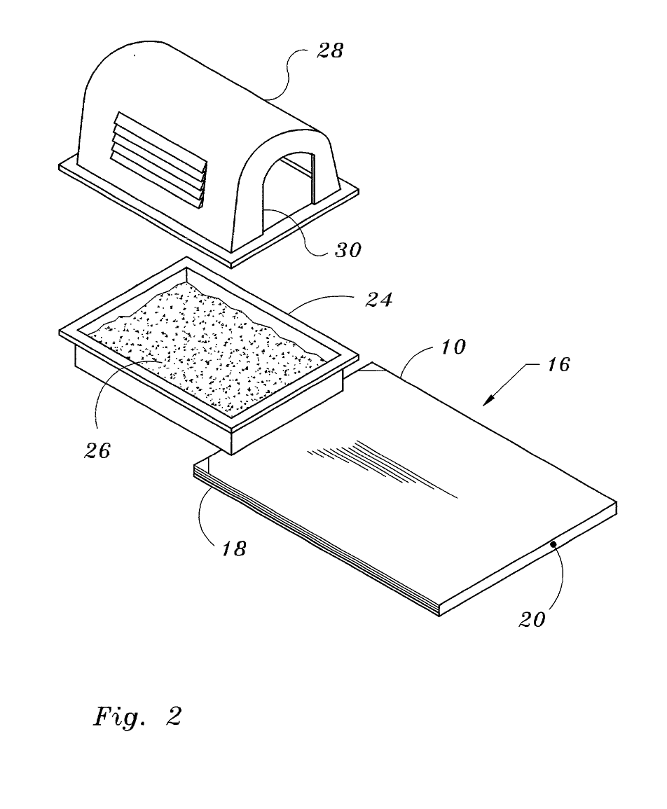

A typical use of the pad 16 is shown in FIG. 2. A cat litter box pan 24 with litter 26 located therein is depicted positioned adjacent to the pad 16. In this depiction, the release liner of the top sheet will have been removed revealing the substratum with the adhesive covering. The edge of the pad 16 is placed under the forward edge of the litter box pan 24. The gum adhesive 20 on the far end of the pad 16 keeps the edges of the substratum 10 in place when the adhesive surface is contacted and released. The weight of the litter box pan 24 keeps the free end from moving under similar circumstances. It is not necessary that the pad 16 be placed in this orientation, but it has been found to be preferred.

As the cat leaves the litter box pan 24, granules of litter 26 stick to the soft paws of the animal. The animal typically then tracks this debris out onto the floor until it eventually falls off. With the invention positioned such that the animal must step on the pad 16 upon leaving the litter box pan 24, the adhesive on the substratum 10 works in two ways. First the adhesive directly pulls much of this free debris off the paws of the animal each time a paw contacts the adhesive. Secondly, the sticky “feel” of the adhesive causes the animal to pull the paw up off the substratum 10 and shake each paw with each step, further dislodging the debris. This debris then falls onto the substratum and is caught by the adhesive.

There are a number of ways to insure the animal steps on the pad 16 upon leaving the litter box pan 24. One way is by using a litter pan hood or house 28. This has other advantages in reducing odor, but is useful with regard to the disclosed invention in that the door 30 provides a limited direction exit from the litter 26. This ensures the animal must step on the pad 16 when leaving the litter box pan 24 with litter 26 on the animal's paws. Any other form of position with obstacles can be used. By placing the litter box pan 24 in a corner of a room, and blocking off a side exit, the animal is assured of a “paw cleaning”. The user may also use a room corner and place a second pad 16 on the remaining open side. This also assures their paws are cleaned upon leaving the litter 26. As the animal's paws are pulled off of the “sticky” surface, a small vertical force is seen in the substratum 10. Since it is economical for the substratum to be thin and pliable, this small load is transferred through to the base 18, which maintains the generally rigid from of the pad 16.

The adhesive on the substratum 10 catches the debris of the tracked out litter 26 and the adhesive holds it on the surface of the substratum 10. When the substratum 10 of the invention becomes soiled through repeated use of the animal, the top sheet can be removed as you would a sheet of paper from a notebook. The user then removes the release liner of the new sheet, revealing the adhesive covering the new substratum.

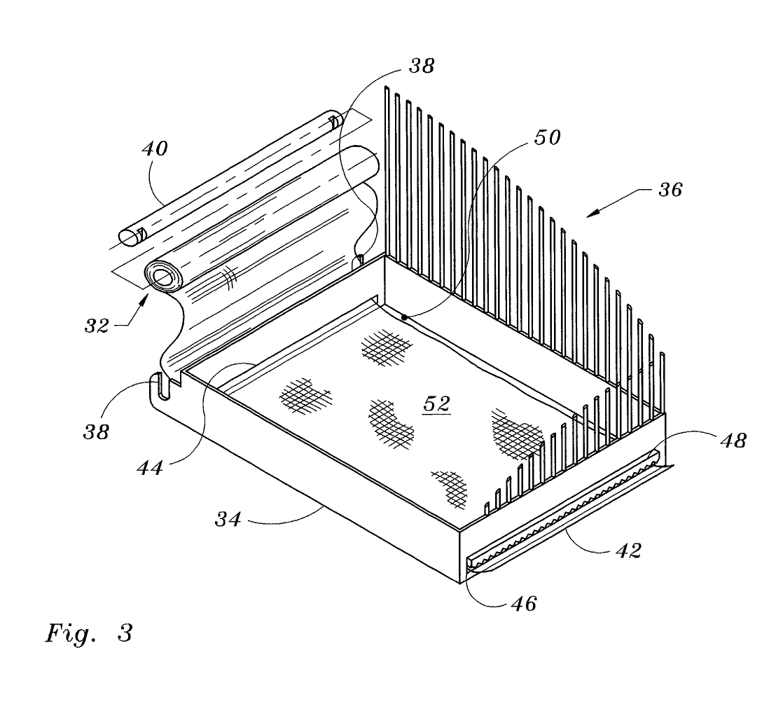

A variation in the form of the invention is shown in FIG. 3. Here the base of the invention is in the form of a structure modified to accept the substratum, which is now a roll 32. The modified base is shown here, as an example, to be the bottom pan 34 of a cage, such as a birdcage 35. Much of the bars of the cage have been removed for illustrative purposes, to better show the invention. In this form, the substratum roll 32 does not require a release liner in that the adhesive is on the inside of each turn of the roll and therefore not accessible until the substratum 32 is unrolled.

The base 34 includes a pair of spool mounts 38 that support the spool 40, that in turn supports the substratum roll 32 through the center thereof. This allows rotational movement of the roll 32 about the spool 40, enabling the free end 42 of the roll 32 to be displaced from the roll 32. The base includes a first slot 44 and a second slot 46 through which the free end 42 can freely pass. Near the second slot 46 is a cutter 48 that enables the substratum to be cut, thereby creating a new free end 42. The first slot 44 and the second slot 46 are shown to be positioned near the inside bottom surface 50 of the base 34. This allows the structural integrity of the base 34 to support any debris that is placed on the extended substratum 52. With the adhesive on the inside of the substratum roll 32, unrolling the substratum roll 32 from the bottom, as shown, positions the adhesive side up on the portion which is the extended substratum 52. Functionally this is very similar to that as previously disclosed other than the replacement of a “sheet” of the substratum. In this case, when the substratum becomes soiled from dropped food, waste and other debris, the user grasps the free end 42, pulling the soiled section of extended substratum 52 through the second slot 46 and unrolling the substratum roll 32 at the same time. When a clean portion section of the extended substratum 52 is visible through the second slot 46, the user parts the substratum 52 with the cutter 48, providing a new free end 42.

Dropped seed shells and other debris will drop and stick to the exposed adhesive, rather than bounce out onto the floor nearby. In addition the cage can be cleaned in a few seconds without opening the door to the cage. This enables a user that is not comfortable with the animal to still clean the cage because there is no chance of contact between the user and the animal.

It should be understood that the invention in the form as shown and described in FIG. 1 could also be used in an application such as this, inside a standard cage without the need for slot openings in the base and spool hangers. Also the substratum roll 32 could have the adhesive on the outside of the roll and unroll from the top to position the adhesive facing up. Though the device would be functional in that form, as disclosed, with the adhesive on the inside and the unrolling from the bottom is preferable.

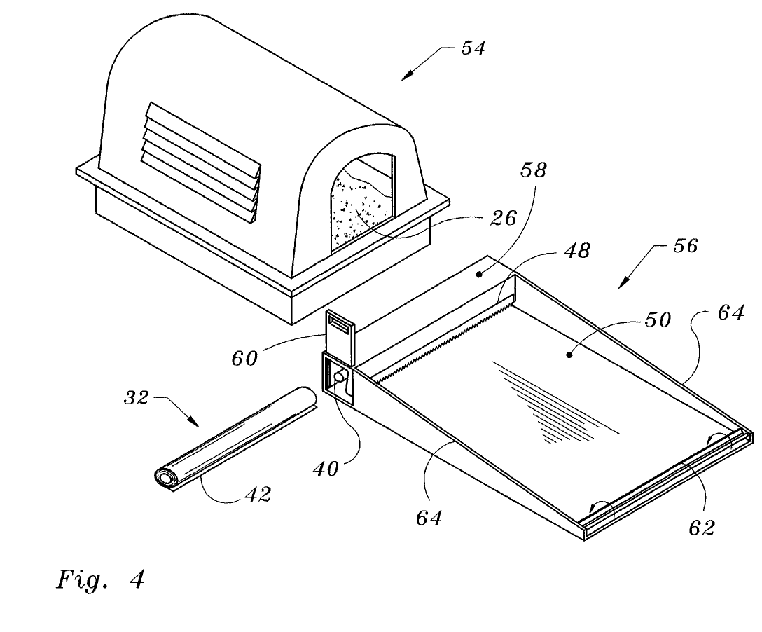

A similar form of the invention to that previously described is shown in FIG. 4, as it would be used as a cat litter box ramp with a cat litter box 54. The substratum is again in the form of a substratum roll 32 with a free end 42 that unrolls from underneath, this the adhesive is on the inside. The spool 40 is shown here to be rigidly mounted to the base 56 and, when assembled, the substratum roll 32 is contained within the roll housing 58 on the spool 40 and enclosed by the door 60. The cutter 48 is positioned on the front end of the roll housing, thus enabling the substratum to be parted, providing a free end 42. There is a gap between the bottom surface 50 of base 56 and the cutting edge of the cutter 48. This gap is where the free end 42 of the substratum roll 32 is guided through. The free end 42 is pulled through this gap and over the bottom portion 50 of the base 56. At the free end 42 is then secured to the base by rotation of the substratum clamp 62 located on the far end of the base 56. The clamp 62 secures the substratum to the base 56 so that it does not move when force is applied to the substratum by way of the adhesive. To enter and exit the litter box 54, the cat or other animal would walk on the adhesive on the substratum, which is supported by the bottom portion 50 of the base 56. As before the adhesive would catch the debris from the animal's paws upon leaving the litter box 54.

In all forms of the invention, the substratum can be clear or colored. In the form as in the current figure, it is in some cases desirable to have the substratum clear or a light color. In this way product identification, such as a logo, can be painted, formed or molded into the bottom portion 50 of the base 56. Then, when the substratum is covering the bottom portion 50, the logo would still be visible.

In this form of the invention, the base 56 also includes sidewalls 64. These add structural rigidity to the product and can be formed in any height or shape that is determined advantageous to the user. A difference between this version of the invention and that of the previous figure lies in the position of the cutter 48. The cutter 48 can be any place associated with the base 56 and in some instances it may be desirable to position it near the roll 32 so that the soiled substratum does not contact the cutter 48 (as in this figure), or at the end of the base 56 so that a substratum clamp 62 is not needed (as in the previous figure).

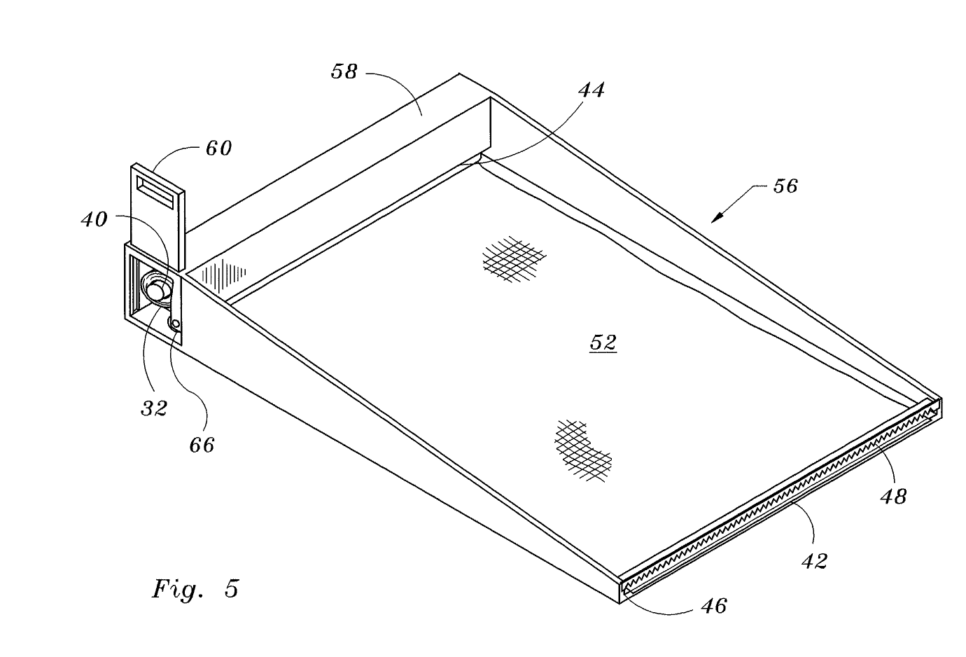

Another example of the invention in the form of a cat litter box ramp is shown in FIG. 5. Similar to the previous figure, the substratum is in a roll 32, which is placed on the spool 40 within the roll housing 58. The door 60 providing access thereto. The roll 32 is shown with an unrolled extended substratum 52 and a free end 42 that passes through the slot 46. As before, a new free end 42 can be made by use of the cutter 48 at the end of the base 56. To aid in the unrolling of the roll 32 and proper placement of the substratum when positioned as the extended substratum 52, a roller 66 is used. This roller 66 is positioned near the slot 44 at the base of the roll housing 58. This roller 66 is rotatably mounted to the base 56, being preferably located within the roll housing 58.

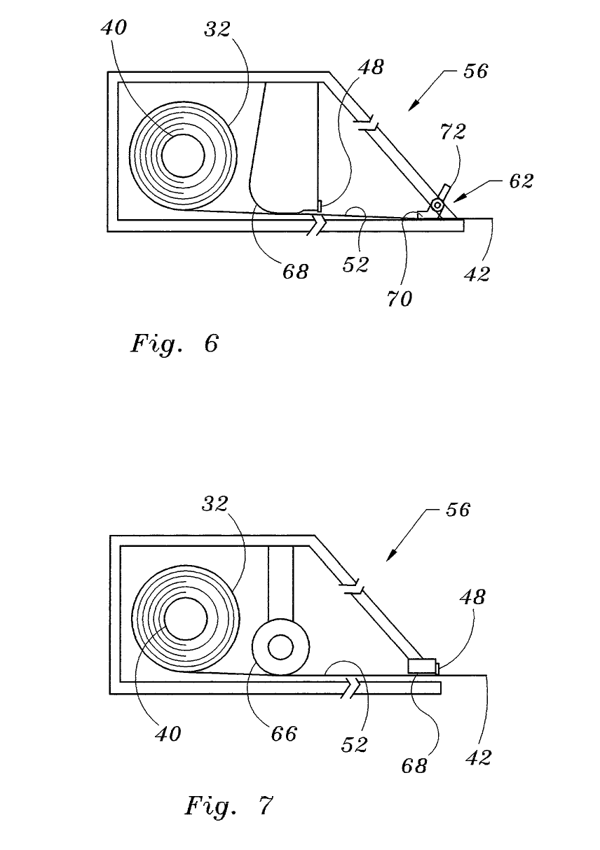

Details of each form of the invention, with the cutter near the roll and at the end of the base, are shown in a shortened side view in FIGS. 6 and 7 respectively. First, in FIG. 6, a version as detailed in FIG. 4 is shown. The roll 32 is rotatably mounted on the spool 40 and the extended substratum 52 extends between the cutter 48 and the clamp 62 with the free end 42 extending past the clamp 62. In any form of the invention, which uses the roll and a built in cutter, it is desirable to include a contact surface 68 where the adhesive on the substratum can cling to when the cut is made. This then provides a free end 42 that is more easily accessible by the user. This is usually best accomplished by providing a substantially flat surface on the roll side of the cutter 58. In this way when the substratum is raised to engage the cutter 48, the adhesive contacts the contact surface 68.

The function of the clamp 62 is also shown here to be pivotally mounted to the base 56 with a flat arm 70 that pushes the substratum into the base 56. It is shown here to include a handle 72 to facilitate rotation of the arm 70, but this and even the rotation action is not critical to the novelty of the invention. A slide mounted clamp or a removable clamp would also function in this application.

The general function of the invention as is shown and described in FIG. 6 is also applicable to FIG. 7. This form of the invention is more similar to that as shown in FIG. 5. Here the roller 66 is mounted to the base 56 and positioned near the roll 32. The cutter 48 is positioned near the end of the base 56, away from the roll 32. The contact surface 68 is positioned near the cutter 48 is shown to be part of the structure which supports the cutter 48. Functionally, it is similar to that as previously noted where the vertical movement of the substratum 52 to cut it on the cutter 48, causes the adhesive to contact the contact surface 68 and releasably secure it thereto. Numerous other forms of this aspect of the invention are considered inherently inclusive with this disclosure.

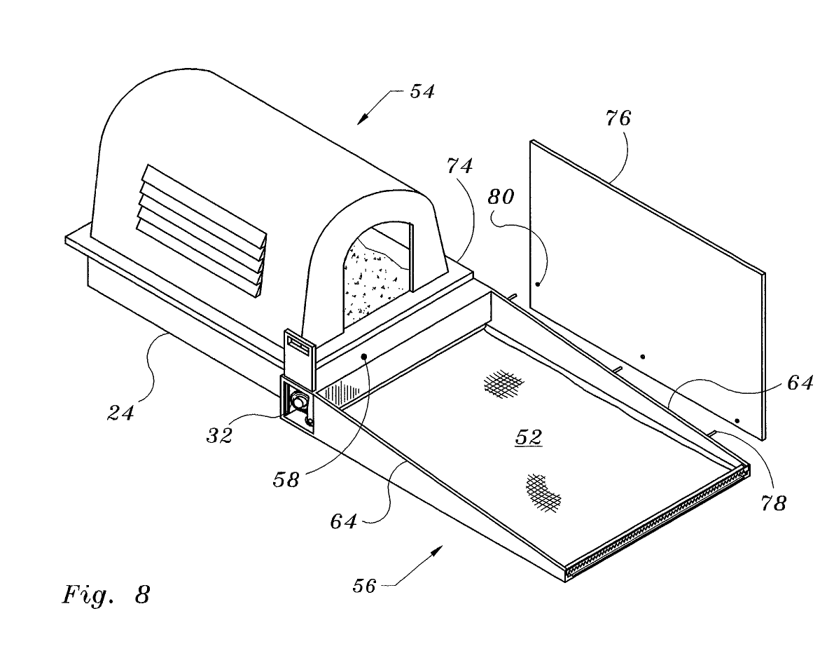

The present invention, in the form of a cat litter box ramp, is further shown in FIG. 8. The upper lip 74 of the litter pan 24 of the litter box 54 is shown to allow receipt of the roll housing 58 of the base 56 of the invention. This, though not necessary, provides a simple interlocking of the invention and the litter box 54. As noted previously, the substratum roll 32 includes an extended substratum 52 through to the end of the base 56. The adhesive on the substratum 52 positioned up away from the base 56, thus providing a “sticky ramp” to and from the litter box 54. To insure the animal uses the ramp, attaching extension walls 76 that can be permanently or releasably mounted to the existing sidewalls 64 can extend the sidewalls 64. The sidewalls 64 of the invention can be made in this higher form as a standard, if a wall is present on one side the higher wall is redundant. This adds unnecessary expense to the product. The increased physical size of permanently high sidewalls on a fully assembled product would increase the storage and shipping size, also needlessly ultimately increasing the cost to the consumer.

An infinite number of fastening methods can be used to attach the extension walls 76 to the invention. For example, pins 78 can be molded or fixed to the sides of the invention. These pins are received by holes 80 in the extension walls 76. Other more traditional forms of attachment such as threaded fasteners, and hook and loop fasteners are also possible variations to mounting these extension walls 76 to some portion of the base 56 of the invention.

It is to be understood that all of the enclosed information as presented is as the preferred embodiment in some form, as seen by the inventor. An infinite number of variations and modifications can be made including the sizing and positioning of various elements of the device, including the specific shape and form of the base.

What is claimed is:

1. A pet debris trap comprising:
a substantially rigid base; and
a substratum with an adhesive on a first side thereof and a second side positioned on said substantially rigid base, the substratum being releasably fastened to said substantially rigid base, whereby debris from a pet would be captured by said adhesive on said first side of said substratum.

2. A trap as in claim 1, wherein said substantially rigid base is a substantially flat board manufactured of a paper material.

3. A trap as in claim 2, wherein said flat board is a cardboard sheet.

4. A trap as in claim 1, wherein said substantially rigid base comprises a formed structure and includes a substratum clamp.

5. A trap as in claim 4, wherein said formed structure is manufactured from a material selected from the group consisting of metal, plastic and wood.

6. A trap as in claim 4, wherein said formed structure is a structure in the form of a bottom pan of a birdcage.

7. A trap as in claim 4, where in said formed structure is a structure in the form of a cat litter box ramp.

8. A trap as in claim 7, wherein said formed structure further includes a side wall, this restricting traffic and debris to said formed structure.

9. A trap as in claim 4, wherein said formed structure further includes a side wall, this restricting traffic and debris to said formed structure.

10. A trap as in claim 9, wherein said sidewall is releasably attached to said formed structure.

11. A trap as in claim 9, wherein said sidewall is a part of said formed structure.

12. A trap as in claim 1, wherein said substratum is comprised of a plurality of stacked sheets releasably fastened to said base at one end of the stack.

13. A trap as in claim 12, wherein said sheets are releasably fastened to said base by use of a gum adhesive.

14. A trap as in claim 12, wherein said substratum also includes a release liner on each sheet, whereby removal of the release liner provides access to said adhesive.

15. A trap as in claim 1, wherein said substratum is comprised of a roll of pliable material with said first side being a medial portion of each layer of the roll.

16. A trap as in claim 1, wherein said base includes a roll support capable of receiving said roll of pliable material.

17. A trap as in claim 16, further comprising a cutter, thus enabling separation of a portion of said substratum from said roll.

18. A trap as in claim 1, wherein said adhesive is a pressure sensitive adhesive.

19. A method of capturing pet debris including the steps of:
providing a device including:
a substantially rigid base; and
a substratum with an adhesive on a first side thereof and a second side positioned on said substantially rigid base, the substratum being releasably fastened to said substantially rigid base;
positioning said device in a pet debris area with said first side of said substratum accessible to said debris; and
allowing said adhesive to capture said debris.

20. A method as in claim 19, further including the step of removing said substratum when soiled by said debris and replacing same with an unsoiled substratum.
